(19) United States
(12) Patent Application Publication
(10) Pub. No.: US 2018/0151057 A1
(43) Pub. Date: May 31, 2018

(54) SYSTEM FOR ACTIVITY MONITORING AND ALERT GENERATION FOR AN ARTICLE STORED IN A RECEPTACLE

(71) Applicant: PEDRO ALBERTO REYNA, HOUSTON, TX (US)

(72) Inventor: PEDRO ALBERTO REYNA, HOUSTON, TX (US)

(21) Appl. No.: 15/361,164

(22) Filed: Nov. 25, 2016

(51) Int. Cl. G08B 25/10; H04W 4/02; G08B 21/18; G08B 21/02

(52) U.S. Cl. CPC G08B 25/10; G08B 21/02; G08B 21/18; H04W 4/02

(57) ABSTRACT

A system for securely storing an article, monitoring an activity on the article and generating an alert upon detection of an activity on the article is disclosed. The system includes a receptacle configured to receive and securely store the article, a triggering means associated with the receptacle, the triggering means being configured to automatically activate during withdrawal of the article from the receptacle and a location tracking means in communication with the triggering means to transmit a location of the article to a central station. The withdrawal of the article from the receptacle activates the triggering means and the associated location tracking means initiating a real-time transfer of the location of the article and the alert to the central station over a wireless communication channel. The receptacle can be a gun holster for securely storing a firearm article.

### BACKGROUND OF THE EMBODIMENT

### Technical Field of the Embodiment

The present embodiment relates to a system and a receptacle for automatically monitoring at least one activity on an article stored in the receptacle. More specifically, the present embodiment relates to gun holsters for law enforcement personnel having an automatic alert generation mechanism during withdrawal of the firearm.

### Description of the Related Art

Law enforcement personnel such as police officers are exposed to violent threats more than any other segment of the domestic population. Many times the situations escalate to a “use of force” before an officer has time to call for backup in form of another squad car, another officer, etc. Sometimes the act of manually picking up a radio or other communication device and calling for backup escalates a situation. Also, the process requires at least one hand and an estimated number of seconds to perform such an act. The existing systems cannot be used for silently reporting the location of an officer and informing the backup team when he or she performs an armed confrontation with criminals.

There are some prior arts disclosing different methods and apparatus for allowing the law enforcement personnel to silently report the location of the officer and inform the backup team upon confrontation with criminals. Some of the patents and applications, which are herein incorporated by reference for their supportive teachings, are as follows:

U.S. Pat. App. No. US 20150254968 A1 filed by Raymon on Mar. 5, 2015, which discloses an apparatus that includes a weapon securing holster and a wireless presence detection antenna, which receives wireless proximity data from a weapon drawn from the holster. Other features may include a sensor, which detects a presence of the weapon, and a processor, which processes sensor data, generated by the at least one sensor and radio frequency signals identifying proximity of the weapon to the wireless presence detection antenna. However the above system do not offer a simple automated system or automated apparatus for that can silently report the location of an officer and inform dispatch or backup team when the officer performs such dangerous activities.

U.S. Pat. No. 5,479,149 A1 issued to Glenn on Dec. 26, 1995, discloses a system having a receiver/recorder/transmitter carried by the officer which can be activated by a manual switch or a sensor switch associated with the weapon holster and weapon to record and transmit a signal indicating removal of the weapon from the holster and record and transmit all audible sounds, conversations and the like that occur in the vicinity of the officer. The information received by the receiver/recorder/transmitter carried by the officer is transmitted to a receiver/recorder/transmitter in the officer's patrol car, which receives the information from the transmitter carried by the officer, records, and transmits it with a longer-range signal to a dispatch station. The information transmitted to the dispatch station will energize an audible or visual signal to alert the dispatcher of a possible life-threatening situation being encountered by the officer with the information transmitted to the dispatcher being recorded and logged in to enable the dispatcher to send assistance or back up officers if deemed necessary. The officer's weapon also includes a sensing and signal transmitting device that will transmit a signal to enable the officer's weapon to be located in the event it is taken from the officer's holster or from the officer by an unauthorized person to facilitate recovery of the weapon and possibly the arrest of the person who took the weapon from the officer. However the above system do not offer a simple automated system or automated apparatus for that can silently report the location of an officer and inform dispatch or backup team when the officer performs such dangerous activities.

U.S. Pat. No. 6,247,623 B1 issued to Joseph on Jun. 19, 2001, discloses a new and improved safety gun holster device capable of securing a firearm. The safety gun holster is provided with an incorporated trigger guard designed specifically to prevent accidental discharge of the weapon. The device also has an incorporated belt clip allowing the device to be freely attached to a belt or a pair of pants worn by a user. The device also has an incorporated gun barrel holder, allowing an additional securing means for a weapon that is placed within the present invention. A cloth cover on the gun barrel holder will insure that the barrel of any weapon placed into the present invention will remain clean. The device also includes a rear mounted strap allowing any weapon placed within the device to be securely positioned in a non-flexible position. However the above device do not offer a simple automated system or automated apparatus for that can silently report the location of an officer and inform dispatch or backup team when the officer performs such dangerous activities.

Hence, it can be seen that there is a need for a simple automated system or automated apparatus that can silently report the location of an officer and inform dispatch or backup team when the officer performs such dangerous activities.

### SUMMARY OF THE INVENTION

The present invention is related to a system and associated apparatus for securely storing an article, monitoring at least one activity on the article, and generation of alert upon detection of an activity on the article. The system for securely storing the article, monitoring at least one activity on the article, and generating an alert upon detection of an activity on the article includes a receptacle configured to receive and securely store the article and a triggering means associated with the receptacle. The triggering means is attached to the receptacle so that when the user withdraws the article from the receptacle, the triggering means gets automatically activated to alert the respective authority. The system further includes a location tracking means in communication with the triggering means to transmit a location of the article, when it is being withdrawn from the receptacle, to a central station. The withdrawal of the article from the receptacle activates the triggering means and the associated tracking means, thereby initiating a real-time transfer of the location of the article. The system also sends an alert to the central station along with the real-time location of the article of the over the wireless communication channel. This allows the real-time tracking of the article in the event of withdrawal of the article from the receptacle.

The article stored in the receptacle can be a firearm and the receptacle is a gun holster. The law enforcement personnel can wear the gun holster externally or under the clothing in a concealed state. The present gun holster is capable of automatically alerting the central station upon detection of withdrawal of the firearm from the gun holster. The information related to the withdrawal of the firearm from the gun holster is automatically sent to the central station as alerts over the wireless communication channel. This enables the central station or the control room to quickly provide necessary back up to the law enforcement personnel engaged in the armed confrontation.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 shows a representative diagram showing the present system for securely storing the article, monitoring at least one activity on the article, and generating an alert upon detection of an activity on the article, according to a preferred embodiment of the present invention; and

FIG. 2 shows a representative diagram of the firearm securely stored in the gun holster with a trigger for setting off the wireless notification, according to a preferred embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

The present disclosure relates to a system and associated apparatus for securely storing an article, monitoring at least one activity on the article, and generating an alert upon detection of an activity on the article. The present system includes an article holder or a receptacle or housing means for securely storing the article. The article holder or the receptacle is provided with an electronic circuitry and associated electronic components to monitor an activity on the article, such as the withdrawal of the article from the receptacle. Further the article holder or the receptacle is provided with necessary electronic components to communicate with a central control station when an activity on the article stored in the receptacle is detected. For example, when a person withdraws the article from the receptacle, the electronic circuitry associated with the receptacle is automatically activated to notify the central control station about the activity on the article in real-time.

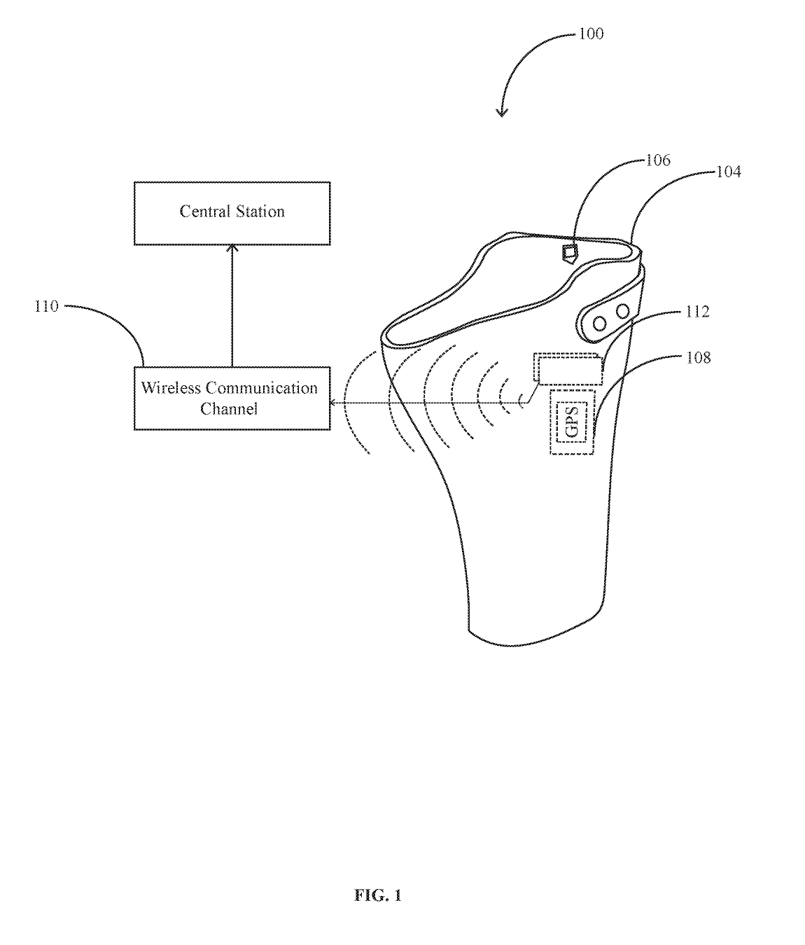

FIG. 1 shows a representative diagram showing the present system 100 for securely storing the article 102, monitoring at least one activity on the article 102, and generating an alert upon detection of an activity on the article 102, according to a preferred embodiment of the present invention. The present system 100 includes a receptacle 104 configured to receive and securely store the article 102 and a triggering means 106 associated with the receptacle 104. The triggering means 106 is attached to the receptacle 104 so that when the user withdraws the article 102 from the receptacle 104, the triggering means 106 gets automatically activated to alert the authorized personnel. The system 100 further includes a location tracking means 108 in communication with the triggering means 106 to transmit a location of the article 102, when it is being withdrawn from the receptacle 104, to a central station. In an embodiment of the present disclosure, the location tracking means 108 of the present system 100 is associated with the receptacle 104 and is in communication with the triggering means 106 to transmit the real-time location of the article 102, when it is being withdrawn from the receptacle 104, to the central station or the control room. The system 100 further includes a wireless communication channel 110 to enable communication between the receptacle 104 and the central station. In short, the withdrawal of the article 102 from the receptacle 104 activates the triggering means 106 and the associated tracking means 108, thereby initiating a real-time transfer of the location of the article 102. The system 100 also sends an alert to the central station along with the real-time location of the article 102 of the over the wireless communication channel 110. This allows the real-time tracking of the article 102 in the event of withdrawal of the article 102 from the receptacle 104.

According to a preferred embodiment of the present disclosure, the article 102 stored in the receptacle 104 is a firearm or a gun 102 and the receptacle 104 is a gun holster 104. The gun holster 104 can be worn by the law enforcement personnel and can be used to securely store the firearm 102 while performing their duty, especially during patrolling time. The design of the gun holster 104 is such that it can comfortably hold the firearm 102 within it and would allow the law enforcement personnel to quickly withdraw the firearm 102 from the gun holster 104 in case of an emergency. The present receptacle 104 or the gun holster 104 is capable of automatically alerting the central station upon detection of withdrawal of the firearm 102 from the gun holster 104. This enables the quick action by the central station or the control station, as the information related to the withdrawal of the firearm 102 from the gun holster 104 and the location of the law enforcement personnel is automatically send to them in real-time. Hence in case of any emergency, the officers or the law enforcement personnel do not have to waste precious time for alerting the central station or the control room regarding the situation at any location. The information related to the withdrawal of the firearm 102 from the gun holster 104 is automatically sent to the central station as alerts over the wireless communication channel 110. This also enables the central station or the control room to provide necessary back up to the law enforcement personnel engaged in the armed confrontation quickly.

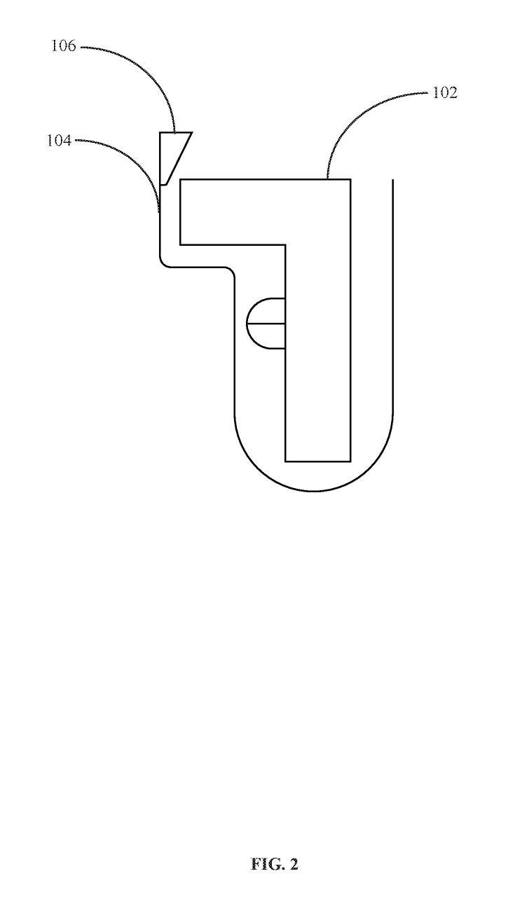

FIG. 2 shows a representative diagram of the firearm 102 securely stored in the gun holster 104, according to a preferred embodiment of the present invention. The triggering means 106 is a switch positioned within the receptacle or the gun holster 104 as shown in FIG. 2. The switch 106 is conveniently positioned inside the receptacle or the gun holster 104 such that when the law enforcement personnel pulls out or withdraws the firearm 102 from the gun holster 104, it automatically operates the switch 106. The switch 106 provided on the gun holster 104 can be a push button switch or a toggle switch or a sensor that gets automatically activated when the firearm 102 is being withdrawn from the gun holster 104. Once the switch 106 is activated during the withdrawal of the firearm 102 from the gun holster 104, the location tracking means 108 associated with the gun holster 104 also gets activated to automatically collect and transfer the real-time location information of the law enforcement personnel to the central station. According to an embodiment of the present disclosure, the location tracking means 108 is a global positioning system (GPS) chip and associated electronic circuitry positioned within the receptacle or the gun holster 104. The switch 106 is electronically connected to the location tracking means 108 or the GPS chip 108 to enable the location tracking process once the switch 106 gets activated. The location tracking means 108 or the GPS chip 108 provided with the receptacle or the gun holster 104 transmits the real-time location to the central station through the wireless communication channel 110.

In a yet another embodiment of the present disclosure, the receptacle or the gun holster 104 includes the switch 106 and associated electronic circuitry to communicate with a wireless radio device of the law enforcement personnel upon withdrawal of the firearm 102 from the gun holster 104. When the law enforcement personnel withdraws the firearm 102 from the gun holster 104, the switch 106 is automatically activated and a signal is sent to the wireless radio device of the law enforcement personnel, which in turn automatically sends alerts to the central station or the control room along with the location information of the law enforcement personnel asking for back up. In some other embodiment, the location tracking means 108 is provided as an integral part of the gun holster 104 along with the switch 106 and the wireless communication means 112. When the law enforcement personnel withdraws his/her firearm 102 from the gun holster 104, the switch 106 gets automatically activated and the location tracking means 108 or the GPS chip 108 incorporated within the gun holster 104 automatically collects the location information. Then the wireless communication means 112 associated with the gun holster 104 transmits the location information and an alert to the central station over the wireless communication channel 110. The wireless communication means 112 transmit the real-time location and the alerts to the central station through the wireless communication channel 110, which includes, but not limited to, radio communication, WLAN, mobile data communication and other wireless communication methods. The wireless communication means 112 is also capable of communicating with the wireless radio device of the law enforcement personnel, in some instances, to automatically send the alert to the central station upon withdrawal of the firearm 102 from the gun holster 104.

In a yet another embodiment of the present disclosure, the receptacle or the gun holster 104 includes the switch 106 to enable automated triggering of the alerts during withdrawal of the firearm 102 from the gun holster 104. The gun holster 104 further includes a wireless communication means 112 that can communicate with a portable radio device of the law enforcement personnel. The radio device performs multiple functions including receiving the location information and alerts from the gun holster 104 and redirecting the location information and alerts to the central station for further action by the control room or the higher authorities. However in all the above embodiment of the present disclosure, the withdrawal of the firearm 102 from the gun holster 104 automatically operates the switch 106 and activates the location tracking means 108 to transmit the real-time location and at least one alert to the central station using the wireless communication means 112 over the wireless communication channel 110. Moreover, the power supply means associated with the gun holster 104 is rechargeable either by connecting it directly to a power outlet or by replacing the batteries stored in the gun holster 104. The present gun holster 104 offers increased security and support to the law enforcement personnel as it automatically sends out the alerts along with the real-time location to the central station so that they can quickly send backup to the particular location.

The foregoing description of the preferred embodiment of the present invention has been presented for the purpose of illustration and description. It is not intended to be exhaustive or to limit the invention to the precise form disclosed. Many modifications and variations are possible in light of the above teachings. For example, the present system 100 and receptacle 104 can be used for secure storage of any type of article 102 and not limited to the storage of firearms 102. For example, the present system 100 and receptacle 104 can be employed at high security areas where precious articles 102 are stored inside the receptacles 104. If somebody try to steal or make an unauthorized withdrawal of the article 102, the switch 106 on the receptacle 104 get activated and alert a central station or control room along with the current location of the receptacle 104. Further the present receptacle 104 can be modified to include a recording means such as a solid state storage means to store the activities on the article 102 after withdrawing it from the receptacle 104. Moreover ordinary people who want to prevent unauthorized use of the firearm can also use the present receptacle 104. It is intended that the scope of the present invention not be limited by this detailed description, but by the claims and the equivalents to the claims appended hereto.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptions or variations of the present invention.

1-10. (Canceled)

11. A gun holster for use by law enforcement personnel for storing a gun and communicating the holster location during removal of the gun therefrom, comprising:
a holster body configured to removably receive the gun;
a switch device affixed to an upper end of said holster body in a position to become automatically activated as the gun is withdrawn from said holster body;
a GPS tracking device and associated electronic circuitry positioned within said holster body electronically connected in communication with said switch device configured to track the holster location in real time; and
wireless communication means selected from the group consisting of a wireless radio device, a wireless local area network (WLAN), and a mobile data communication device, operatively connected in communication with said GPS tracking device and configured to transmit an alert notification signal and the holster location to a central law enforcement station via a wireless communication channel; wherein
said switch device is automatically activated as the gun is withdrawn from said holster body to transmit the alert notification signal and the real time location of the holster from said GPS device to the central law enforcement station via the wireless communication means to enable deployment of other law enforcement personnel to quickly provide necessary back up to the location of the holster wearer.
